(19) United States
(12) Patent Application Publication
(10) Pub. No.: US 2025/0209926 A1
(43) Pub. Date: Jun. 26, 2025

(54) REAL-TIME MONITORING AND REROUTING ADVISORIES ON REGULATED FLIGHTS

(71) Applicant: THE BOEING COMPANY, Arlington, VA (US)

(72) Inventors: Alejandro GÜEMES JIMÉNEZ, Getafe (ES); Pablo COSTAS, Majadahonda (ES); Javier LOPEZ LEONES, Majadahonda (ES); Nicolas PEÑA ORTIZ, Madrid (ES); Andrés MUÑOZ HERNÁNDEZ, Madrid (ES); Elisa MORALES TIRADO, Madrid (ES)

(21) Appl. No.: 18/670,618

(22) Filed: May 21, 2024

Related U.S. Application Data
(60) Provisional application No. 63/614,392, filed on Dec. 22, 2023.

(51) Int. Cl. G08G 5/00

(52) U.S. Cl. CPC G08G 5/34; G08G 5/20; G08G 5/55; G08G 5/59

(57) ABSTRACT

The present disclosure provides techniques and systems for improved flight planning. A regulation that restricts flight operations for one or more locations during one or more windows of time is accessed. It is determined, based on the regulation, that a scheduled flight will be delayed by the regulation. One or more alternative routes for the scheduled flight are identified, and a first alternative route of the one or more alternative routes is submitted as an updated flight plan for the scheduled flight.

### CROSS-REFERENCE TO RELATED APPLICATION

This application claims benefit of U.S. Provisional patent application Ser. No. 63/614,392, filed Dec. 22, 2023, which is incorporated herein by reference in its entirety.

### FIELD

Aspects of the present disclosure relate to flight monitoring and routing, and, more specifically, to monitoring flights and generating reroutes based on regulatory changes.

### BACKGROUND

In some conventional systems, flight monitoring and tracking is carried out using a combination of manual Collaboration Human Machine Interface (CHMI) inputs and manual inputs (e.g., from ground handling agents) to the flight monitoring system. Delay in the entry of messages by handling agents can occur due to a wide variety of operational reasons. These delays can substantially inhibit planning at the departure and arrival airports for a flight. Additionally, manual sourcing of flight progress through can be inefficient as well as challenging for personnel during times of weather and air traffic control (ATC) disruption.

For example, many airlines currently have extremely limited prior visibility of the temporary regulations imposed to their ongoing or scheduled flights, inhibiting the airline's ability to file new flight plans that could avoid or mitigate the regulation(s). As one example, ground stops may be ordered in response to inclement weather at the departure airport, the arrival airport, or along the planned route. These temporary regulations or restrictions can introduce substantial delay.

### SUMMARY

The present disclosure provides a method in one aspect, the method including: accessing a regulation that restricts flight operations for one or more locations during one or more windows of time; determining, based on the regulation, that a scheduled flight will be delayed by the regulation; identifying one or more alternative routes for the scheduled flight; and submitting a first alternative route of the one or more alternative routes as an updated flight plan for the scheduled flight.

In one aspect, in combination with any example method above or below, the method further includes determining that the first alternative route is not subject to the regulation.

In one aspect, in combination with any example method above or below, the method further includes determining that a delay of the first alternative route is less than the delay of the scheduled flight.

In one aspect, in combination with any example method above or below, the method further includes outputting, via a graphical user interface (GUI), an indication that the scheduled flight is affected by the regulation.

In one aspect, in combination with any example method above or below, the method further includes highlighting the indication based on a length of the delay.

In one aspect, in combination with any example method above or below, highlighting the indication based on the length of the delay comprises, in response to determining that the delay is greater than a threshold, emphasizing the indication.

In one aspect, in combination with any example method above or below, the method further includes outputting, for each respective alternative route of the one or more alternative routes, a respective indication via a graphical user interface (GUI).

In one aspect, in combination with any example method above or below, the method further includes determining, for each respective alternative route of the one or more alternative routes, a respective regulatory delay.

In one aspect, in combination with any example method above or below, the method further includes highlighting each respective indication based on the respective regulatory delays.

In one aspect, in combination with any example method above or below, highlighting each respective indication comprises, in response to determining that a delay of first alternative route is lower than the delay of the scheduled flight, emphasizing the indication of the first alternative route.

Other aspects of this disclosure provide one or more non-transitory computer-readable media containing, in any combination, computer program code that, when executed by the operation of a computer system, performs operations in accordance with one or more of the above methods, as well as systems comprising one or more computer processors and one or more memories containing computer-executable instructions that, when executed by the one or more computer processors, perform operations in accordance with one or more of the above methods.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 depicts an example flight tracking system, according to some aspects of the present disclosure.

FIG. 2 depicts an example architecture for delay monitoring and alternative route evaluation, according to some aspects of the present disclosure.

FIG. 3 is a flow diagram depicting an example method for regulation monitoring and flight plan modification, according to some aspects of the present disclosure.

FIG. 4 is a flow diagram depicting an example method for flight plan modification, according to some aspects of the present disclosure.

FIG. 5 depicts an example computing device for regulation monitoring, according to some aspects of the present disclosure.

### DETAILED DESCRIPTION

The present disclosure provides techniques and systems to dynamically monitor flights which are (or may be) affected by regulations or restrictions (e.g., temporary flight restrictions (TFRs) or ground stops). In some aspects, the systems can further identify and propose alternative routes to avoid such restrictions.

In some aspects, by leveraging data provided by various sources (e.g., Air Traffic Management organizations), the system allows users (e.g., dispatchers) to track, in real-time (or near real-time), the progress for upcoming regulated flights. Although short-delay regulations may not be worth evaluating or responding to in some cases, high-delay regulations (e.g., regulations that may result in substantial delay on one or more flights) can have a significant impact on airlines' operational efficiency and customer satisfaction. In some aspects, for such cases where long delays are anticipated, the system can evaluate and provide alternative routes (if available) that may partially or completely mitigate the impact of the regulation(s) on the flight (e.g., reducing or eliminating the delay).

In some aspects, the system comprises of three modules: a database for storing incoming data, a backend for managing data subscriptions and parsing received data, and a frontend for providing a visual real-time representation of flight and regulation status and other relevant data. In some aspects, the backend of the system can self-manage subscriptions (e.g., through the Advanced Message Queuing Protocol (AMQP) and/or request-reply operations), which allows for efficient and reliable data transfers. In some aspects, the parsed data can then be written to the database, which is used by the frontend to generate a real-time display of the flight information.

In some aspects, using this automatically collected flight information, the system may have sufficient time to identify and propose a new flight plan, mitigating costs or other issues due to delays at arrival (e.g., which may cause missed flight connections for passengers). In conventional systems, it is common for a large percentage of flights (e.g., more than half of all flights) to be impacted by a (temporary) regulation with a ground delay greater than 5 minutes. Using the described techniques, the systems disclosed herein many continuously monitor the various regulations imposed to current or scheduled flights, and use this information to improve the routings. Such a rerouting service may result in improved on-time departure, reduced delays, and reduced costs.

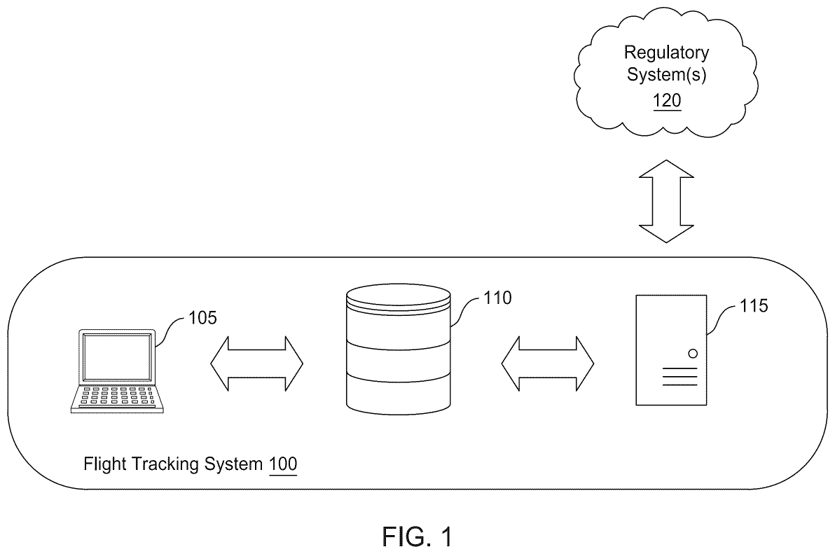

FIG. 1 depicts an example flight tracking system 100, according to some aspects of the present disclosure.

As illustrated, the flight tracking system 100 comprises three components, including a database 110, a backend server 115, and a frontend interface 105. The backend server 115 is configured to receive regulatory data (which may include flight data, as discussed in more detail below) from the regulatory system(s) 120. Generally, the regulatory system(s) 120 may refer to any source of regulatory information, such as one or more servers of the Federal Aviation Administration (FAA).

Upon receiving the regulatory data, the backend server 115 parses the information provided and/or stores the data in the database 110. In some aspects, the backend server 115 also provides the received flight traffic data to the frontend interface 105 (or the frontend interface 105 may retrieve the data from the database 110) for user interaction and visualization. In some aspects, the frontend interface 105 may provide a web-based, real-time visual representation of regulatory updates and flight tracking. In aspects, a variety of steps may be performed by the backend server 115 to receive or retrieve the regulatory data from the regulatory system(s) 120. For example, the backend server 115 may first establish a connection with the regulatory system(s) 120 (or a message broker) using AMQP.

In some aspects, the connection process may include authenticating the server's identity, and/or implementing security measures to establish a secure and reliable communication channel between the two entities. Upon successful connection, the backend server 115 may subscribe to one or more services or queues containing published regulatory data from the regulatory system 120, as discussed in more detail below. Depending on the system's requirements, in some aspects, the subscription may be durable (e.g., remaining across server restarts). In other aspects, the subscription may be transient (e.g., where a new subscription is required when the server restarts). In some aspects, the backend server 115 may retrieve or receive regulatory data continuously from the regulatory systems 120 through the subscription(s). In some aspects, the backend server 115 may check the subscribed queue periodically (e.g., at defined time intervals) for new messages (or new regulatory data). In some aspects, new messages (or new regulatory data) may be pushed to the backend server 115 as they arrive in the queue.

In some aspects, the backend server 115 may establish error handling mechanisms to manage errors or potential data losses. For example, the backend server 115 may set up a timer that is programmed to monitor the frequency of incoming messages. If the backend server 115 does not receive a message within a defined time frame (e.g., 5 minutes), the backend server 115 may trigger a procedure to check the status of the connection. In some aspects, the backend server 115, upon detecting a disconnection, may automatically attempt to reconnect to the regulatory system(s) 120 (or the message broker).

In some aspects, the backend server 115 subscribes to two services or data sources. The first may be a subscription to a “REGULATIONS” topic that provides information for current (e.g., active) regulations that may affect flights in one or more geographic areas. For example, the ongoing regulations may include weather-based ground stops at one or more airports. In some aspects, once a message with regulation data is received, the backend server 115 may parse the information provided to identify the regulation information (e.g., an identifier of a currently active regulation). In some aspects, the backend server 115 may use this regulation identifier information to search a second service (e.g., a “Flight List by Measure” request-reply service) to find a list of flights, operated by the airline to which the backend server 115 corresponds, that are (or may be) affected by the specified regulation(s). In some aspects, the information about pending regulations, as well as the information about flights affected by such regulations, may be collectively referred to as “regulatory data,” and may be received from one or more data sources or regulatory systems 120.

In the illustrated example, the frontend interface 105 provides the user with a web-based interface where the regulated flights are tracked. In some aspects, when a regulated flight has a substantial delay (e.g., above a defined threshold) due to regulation(s), the system may evaluate a set of potential alternative routes to determine whether any other routes can be used to avoid the regulation(s) that are affecting the flight.

For example, suppose the current flight plan passes through a given sector, and the relevant regulation indicates a maximum number of aircraft in the given sector (e.g., where the ATC assigned to the sector can manage N aircraft at a time). Suppose further that, based on filed flight plans and/or current flight data (e.g., the current location and speed of each active flight), the sector is predicted to have more than N aircraft at a (future) time when the current flight is predicted to pass through the sector. In some aspects, flight(s) which have not-yet departed may therefore be issued a ground-stop delay, allowing the sector to clear some before the flight(s) reach it (e.g., such that the total number of flights in the sector at any given time remains at or below the number that the assigned ATC can handle). In some aspects, however, if an alternate route can be found (e.g., a somewhat longer flight path that avoids the sector), the system may identify this alternative and propose it as the new flight plan (which may allow for immediate, or at least sooner, departure than if the original flight plan is maintained).

In addition to sector capacity, one other common example of regulations which cause ground-stops and delay flights include inclement weather at the origin airport, departure airport, or along the planned route. Another common example is industrial action along the route (e.g., if ATC is temporarily unavailable or operating with reduced capacity in a given sector, forcing flights to route around the sector or suffer delay). Aspects of the present disclosure are readily applicable to any regulation that may cause delay for departing flights.

In some aspects, the frontend interface 105 may display information for any currently regulated flights (e.g., planned flights which have not-yet departed, but are subject to one or more regulations that are currently causing a delay). For example, in some aspects, the frontend interface 105 provides a table with the relevant information from the last message for each flight. In some aspects the frontend interface 105 may display a subset of flights, such as only flights with Estimated Off Block Time (EOBT) from three hours prior to the current time and through six hours after the current time. In some aspects, the frontend interface 105 only outputs flights where the current flight state is anything prior to an “airborne” state (e.g., where the state is “boarding,” “boarded,” “taxiing,” and the like). In some aspects, the table may include additional relevant information for each flight, such as the call sign, the aircraft registration, the departure and arrival airports, the EOBT, the regulation ID(s) of any regulation(s) affecting the flight, the expected or predicted delay(s), and the planned route or flight plan (e.g., the International Civil Aviation Organization (ICAO) route code).

In some aspects, the frontend interface 105 allows users to interact with the data, such as by filtering the table based on departure airport, arrival airport, or any other parameter. Similarly, in some aspects, the frontend interface 105 allows the information to be sorted or ordered by any parameter (e.g., by delay, by departure time, and the like), such as by clicking on the column header.

In some aspects, the frontend interface 105 can dynamically adjust the output based on delay status. For example, in some aspects, the frontend interface 105 may highlight rows in a given color (such as red) or otherwise bold or emphasize the row if the flight is subject to a regulatory delay of greater than a configurable threshold (e.g., greater than or equal to 30 minutes).

In some aspects, the user may interact with the frontend interface 105 to view additional information. For example, the user may click or otherwise select a given flight's call sign to view more information about the flight itself, and/or select the indicated regulation identifier(s) to view additional information about the relevant regulation(s) affecting the flight.

In some aspects, the additional regulation information contains any relevant information of the given regulation and the data of the flight(s) that are affected by that regulation. For example, the frontend interface 105 may output or display the regulation ID, the state of the regulation (e.g., active, expired, planned, and the like), the reason for the regulation (e.g., weather, sector capacity, and the like), a subtype of the regulation (if applicable), the applicability start and end times (e.g., when the regulation becomes active and when it expires), a description of the regulation or restriction, expected or allowable traffic volume, location of the regulated area, maximum and/or minimum flight levels (e.g., if there are allowable altitudes not subject to the regulation), and the like.

In some aspects, the regulation information may additionally or alternative include a table indicating the flight(s) that are regulated by the regulation (e.g., as indicated by the regulator system(s) 120). For example, the table may include the call sign, aircraft registration, departure and arrival aerodromes, EOBT, delay, and ICAO route for each affected flight.

In some aspects, when a user selects a specific flight, the frontend interface 105 may output the relevant flight information, such as the call sign, the aircraft registration, the departure and arrival aerodromes, the EOBT, the flight delay, the most penalizing regulation (e.g., the regulation that is causing the largest delay for the flight), the flight state (e.g., “boarding”), and the ICAO route. In some aspects, an additional table may be provided for the specific flight, where all regulations that are affecting the flight are provided. As above, this table may include information for each regulation such as the regulation ID, the regulation state, the regulation reason, the regulation subtype, the regulation applicability (e.g., time(s) when the regulation is applied), the regulation location type, ID, affected flight levels and the regulation description.

In some aspects, as discussed above, if a flight has a regulatory delay greater than 30 minutes (or some other configurable threshold) and it is in a pre-departure state, the alternative routes may be evaluated to see whether an alternative route with no (or fewer) regulations can be provided. In some aspects, once the alternative routes are evaluated, they are depicted in a table via the frontend interface 105. In some aspects, the alternative route(s) are colored, highlighted, or otherwise modified to illustrate or visualize their state. For example, the frontend interface 105 may highlight an alternative route in red if the route has one or more errors (e.g., the route is not available or applicable, such as because the current aircraft is not able to fly that distance). As another example, the frontend interface 105 may highlight the route in another color (e.g., orange) if the route is still regulated (e.g., the delay of the alternative may be better, worse, or comparable to the current flight). In some aspects, the frontend interface 105 may highlight the route in another color (e.g., green) if the route has applicable regulations and/or has on delays. That is, if such an alternative route is taken, the flight could leave immediately to avoid delays.

In some aspects, the backend server 115 may comprise one or more physical servers, cloud servers, or a combination thereof. The backend server 115 may also integrate additional hardware components as needed, such as network interfaces, storage systems, and security applications, to enhance performance and data security.

In some aspects, the backend server 115, the database 110, and the frontend interface 105 may communicate with each other via a network. In some aspects, the backend server 115, the database 110, and the frontend interface 105 may be located remotely from each other, and the network may include or correspond to a wide area network (WAN), the Internet, an intranet, or any combination of suitable communication mediums that may be available, which may include wired, wireless, or a combination of wired and wireless links. In some aspects, the backend server 115, the database 110, and the frontend interface 105 may be local to each other (e.g., within the same local network and/or the same hardware system), and communicate with one another using any appropriate local communication medium, such as a local area network (LAN) (including a wireless local area network (WLAN)), hardwire, wireless link, or intranet, etc.

The network may be designed to provide connectivity not only for the depicted components but also for other systems, components, or resources within the flight tracking system 100. It may be implemented using protocols such as Transmission Control Protocol (TCP) and/or Internet Protocol (IP), to ensure reliable, secure, and standardized communication. In some aspects, the flight tracking system 100 may represent a cloud computing architecture, where the backend server 115, the database 110, and the frontend interface 105 may operate through a centralized cloud computing platform.

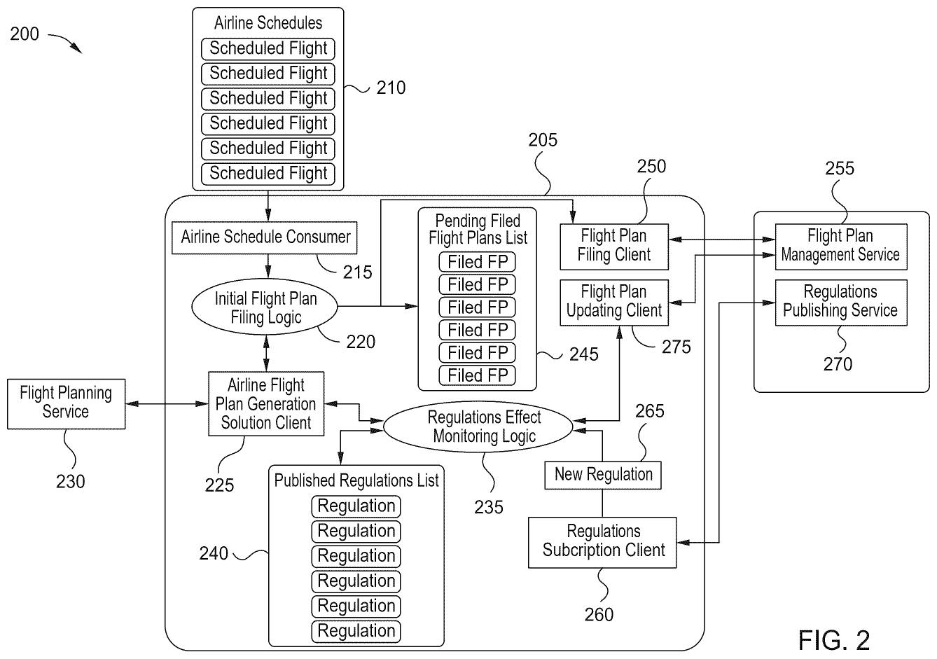

FIG. 2 depicts an example architecture 200 for delay monitoring and alternative route evaluation, according to some aspects of the present disclosure.

In the illustrated example, airline schedules 210 (e.g., a set of scheduled flights) are provided to an airline flight plan (FP) monitoring system 205. In some aspects, the airline flight plan monitoring system 205 corresponds to the flight tracking system 100 of FIG. 1. Specifically, the airline schedules 210 are accessed by an airline schedule consumer 215, which provides the scheduled flights (in the airline schedules 210) to a component for initial flight plan filing logic 220. The initial flight plan filing logic 220 also interfaces with an airline flight plan generation solution client 225. The airline flight plan generation solution client 225 may receive data from various sources, including one or more flight plan sources (e.g., a flight planning service 230 that provides potential routes based on scheduled flights, such as based on departure and arrival airports) and regulations effect monitoring logic 235. The regulations effect monitoring logic 235 may evaluate a published regulations list 240 (e.g., a set of regulations that have been published by a regulatory system 120) in order to assist the airline flight plan generation solution client 225. For example, the regulations effect monitoring logic 235 may allow the airline flight plan generation solution client 225 to select a flight plan, from the alternatives offered by the flight planning service(s) 230, based on the regulations indicated by the regulations effect monitoring logic 235 (e.g., selecting a flight plan that is not affected, or is minimally affected, by the current regulations or restrictions).

As illustrated, the initial flight plan filing logic 220 may then add the selected flight plan to a pending filed flight plans list 245 (containing filed FPs that have been submitted to the relevant regulatory authorities). In the depicted example, a flight plan filing client 250 can submit these selected FPs (from the pending filed flight plans list 245) to a flight plan management service 255 (e.g., the relevant regulatory body or bodies). In the illustrated example, the airline FP monitoring system 205 further includes a regulations subscription client 260 that receives regulation updates (e.g., new regulations 265) from the regulatory entities (e.g., one or more regulations publishing services 270, such as via the regulatory systems 120), and provides any new regulations to the regulations effect monitoring logic 235 (which may update the published regulations list 240 accordingly).

Further, the airline FP monitoring system 205 includes a flight plan updating client 275 that can be used to respond to updated regulation data (e.g., new regulations 265 in the published regulations list 240). For example, as discussed above, the flight plan updating client 275 may work with the other depicted components to detect that a given scheduled flight is expected to be delayed beyond a threshold amount based on one or more (new) regulations. The flight plan updating client 275 may then use components such as the flight planning service 230 and the regulations effect monitoring logic 235 to identify alternative route(s) for the flight, evaluate the effect that any published regulations may have on the alternative, and the like. In some aspects, as discussed above, the flight plan updating client 275 (or another component of the system) may output the alternatives for a user to review and select one, if desired. In some aspects, when the user selects an alternative, the flight plan updating client 275 may be used to submit the revised flight plan to the flight plan management service 255.

Although the illustrated example depicts a variety of discrete components for conceptual clarity, in various aspects, the operations of the depicted components (and others not illustrated) may be combined or distributed across any number of components and systems.

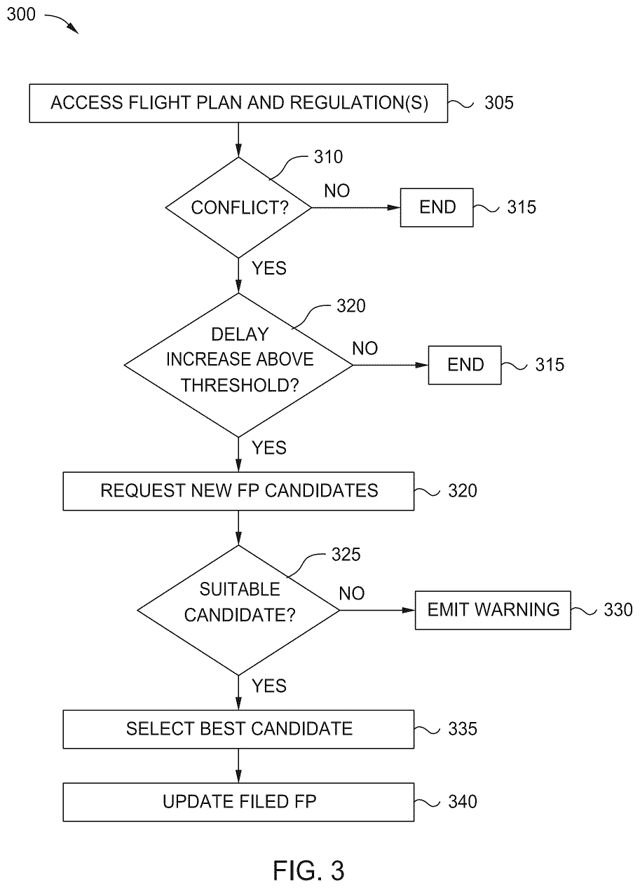

FIG. 3 is a flow diagram depicting an example method 300 for regulation monitoring and flight plan modification, according to some aspects of the present disclosure. In some aspects, the method 300 is performed by a flight tracking system, such as the flight tracking system 100 of FIG. 1, and/or by an airline FP monitoring system, such as the airline FP monitoring system 205 of FIG. 2.

As illustrated, at block 305, the system accesses flight plan (e.g., a filed or planned FP), as well as one or more regulation(s) (e.g., new regulations received after the flight plan was planned and/or filed) that may be relevant to the FP. As used herein, “accessing” data may generally include receiving, requesting, retrieving, obtaining, or otherwise gaining access to the data. At block 310, the system compares the flight plan with the regulation(s) in order to determine whether there is a conflict. That is, whether the regulation(s) affect the flight plan. In some aspects, evaluating this conflict is referred to as a “4D” evaluation, to reflect that the system determines whether the new regulation and the flight plan overlap in time and space. That is, the system determines whether the flight plan crosses the physical area covered by the regulation (e.g., in three-dimensional space) as well as whether the aircraft will be in the regulated space at a time when the regulation is active.

As illustrated, if no conflict exists, the method 300 terminates at block 315. If a potential conflict exists, the method 300 continues to block 320, where the system evaluates whether the delay increase (e.g., the amount of delay attributable to the new regulation) exceeds a configurable threshold (e.g., greater than thirty minutes). If not, the method 300 terminates at block 325. If, at block 320, the system determines that the new delay exceeds the threshold, the method 300 continues to block 320. At block 320, the system can request a set of new FP candidates, as discussed above. For example, the system may determine whether there are any alternative routes (from the same departure airport and to the same arrival airport) that avoid the regulation (e.g., that go around the regulated area, or that pass through the regulated area at a time when the regulation will be inactive).

In some aspects, as discussed above, these alternatives may be generally less desirable than the original plan for a variety of reasons (e.g., flying a longer distance, using additional fuel, requiring additional time, and the like). However, if the delay caused by the regulation is sufficiently long, such alternatives may be worthwhile.

In the illustrated example, at block 325, the system can then evaluate the candidate alternative flight plans to determine whether any alternative routes are suitable (e.g., whether any other routes are able to avoid the new regulation(s) or otherwise reduce the overall delay). For example, the system may determine whether the total delay caused by at least one re-route is less than the current delay caused by the regulation. If not, the method 300 continues to block 330, where the system may generate and output an alert or warning to one or more users (e.g., the dispatcher, the pilot(s) of the flight, and the like). For example, the system may indicate that the flight is affected by a regulatory delay which cannot be mitigated.

If at least one suitable candidate alternative exists to reduce the delay, the method 300 continues to block 335. At block 335, the system (or, in some cases, a user) may evaluate the list of alternatives to select the best candidate. Generally, the best candidate may be defined by a number of factors, such as the predicted delay of the alternative (e.g., seeking to minimize the total delay), the additional fuel consumed by the alternative (e.g., seeking to minimize the fuel consumption), any additional resources consumed and/or maintenance that will be needed based on the alternative (e.g., to minimize this resource usage), and the like. In some aspects, the system may itself select the best candidate (e.g., based on weighted rules indicating which factors should be considered, as well as how heavily, when selecting alternatives). In some aspects, the system outputs the alternatives and allows a user (e.g., the dispatcher) to select one.

As illustrated, at block 340, the system may then automatically update the filed FP. For example, as discussed above, the system may file the revised flight plan to indicate the new alternative route, requesting regulatory approval. In this way, the aircraft may depart immediately (or at least sooner than it otherwise would), reducing delay and improving outcomes.

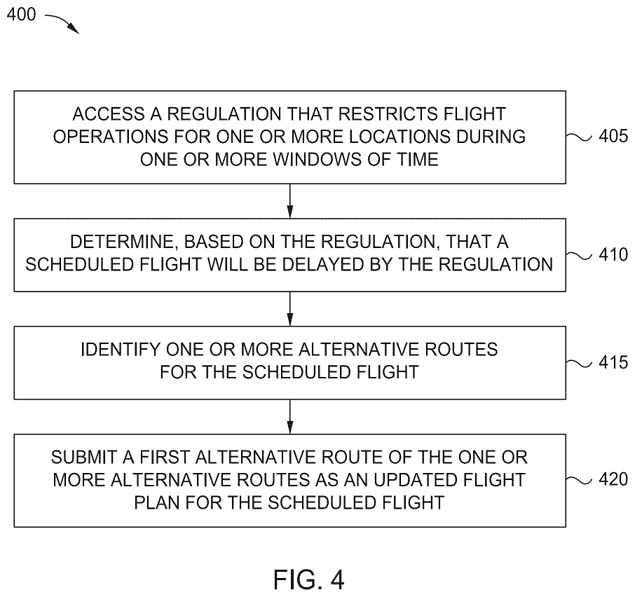

FIG. 4 is a flow diagram depicting an example method 400 for flight plan modification, according to some aspects of the present disclosure. In some aspects, the method 400 is performed by a flight tracking system, such as the flight tracking system 100 of FIG. 1, and/or by an airline FP monitoring system, such as the airline FP monitoring system 205 of FIG. 2.

At block 405, a regulation (e.g., the new regulation 265 of FIG. 2) that restricts flight operations for one or more locations during one or more windows of time is accessed (e.g., from a regulatory system 120 of FIG. 1).

At block 410, based on the regulation, it is determined that a scheduled flight (e.g., from a pending filed flight plans list 245 of FIG. 2) will be delayed by the regulation (e.g., by the regulations effect monitoring logic 235 of FIG. 2).

At block 415, one or more alternative routes for the scheduled flight are identified (e.g., using a flight planning service 230 of FIG. 2).

At block 420, a first alternative route of the one or more alternative routes is submitted as an updated flight plan for the scheduled flight (e.g., by the flight plan updating client 275).

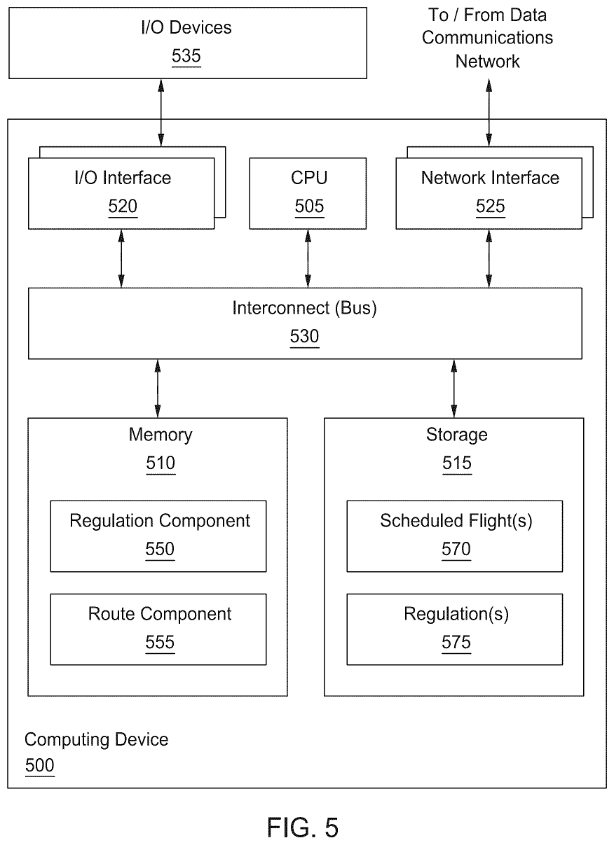

FIG. 5 depicts an example computing device 500 for regulation monitoring, according to some aspects of the present disclosure. Although depicted as a physical device, in some aspects, the computing device 500 may be implemented using virtual device(s), and/or across a number of devices (e.g., in a cloud environment). In some aspects, the computing device 500 corresponds to or comprises a flight tracking system, such as the flight tracking system 100 of FIG. 1, and/or by an airline FP monitoring system, such as the airline FP monitoring system 205 of FIG. 2.

As illustrated, the computing device 500 includes a CPU 505, memory 510, storage 515, one or more network interfaces 525, and one or more I/O interfaces 520. In the illustrated aspect, the CPU 505 retrieves and executes programming instructions stored in memory 510, as well as stores and retrieves application data residing in storage 515. The CPU 505 is generally representative of a single CPU and/or GPU, multiple CPUs and/or GPUs, a single CPU and/or GPU having multiple processing cores, and the like. The memory 510 is generally considered to be representative of a random access memory. Storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some aspects, I/O devices 535 (such as keyboards, monitors, etc.) are connected via the I/O interface(s) 520. Further, via the network interface 525, the computing device 500 can be communicatively coupled with one or more other devices and components (e.g., via a network, which may include the Internet, local network(s), and the like). As illustrated, the CPU 505, memory 510, storage 515, network interface(s) 525, and I/O interface(s) 520 are communicatively coupled by one or more buses 530. In the illustrated aspect, the memory 510 includes a regulation component 550 and a route component 555.

Although depicted as discrete components for conceptual clarity, in some aspects, the operations of the depicted components (and others not illustrated) may be combined or distributed across any number of components. Further, although depicted as software residing in memory 510, in some aspects, the operations of the depicted components (and others not illustrated) may be implemented using hardware, software, or a combination of hardware and software.

In the illustrated aspect, the regulation component 550 (which may correspond to the regulations effect monitoring logic 235 and/or the regulations subscription client 260 of FIG. 2) may be used to access or receive new or updated regulation information (e.g., from a regulatory system 120 of FIG. 1) and determine which flight(s) are affected by the regulation. In some aspects, some or all of the affected flights are indicated by the regulatory system (e.g., based on filed flight plans). In some aspects, some or all of the affected flights are determined by the regulation component 550. In some aspects, the regulation component 550 further identifies, predicts, or otherwise determines an expected delay to any affected flight(s) based on the applicable regulation(s). For example, the regulation component 550 may determine how long the regulation is expected to be active, how long the flight will have to wait until it can fly while satisfying the regulation, and the like.

In the illustrated example, the route component 555 (which may correspond to the airline schedule consumer 215, the initial flight plan filing logic 220, the airline flight plan generation solution client 225, the flight planning service 230, the flight plan filing client, and/or the flight plan updating client 275, each of FIG. 2) may be used to identify and evaluate alternative route(s) to minimize regulatory delay. For example, as discussed above, the route component 555 may identify or generate a list of alternative routes that begin at the same departure airport and end at the same arrival airport as the original flight plan. As discussed above, these routes may take alternative paths (e.g., using different flight corridors and/or a different ICAO route). In some aspects, the route component 555 can then evaluate the applicable regulations on each alternative route, and/or may indicate the alternative route(s) to the regulation component 550. The route component 555 and/or regulation component 550 can thereby determine or predict delay(s) to each alternative path, allowing the computing device 500 and/or a user to select the best alternative that optimizes one or more parameters (e.g., minimizing delay and/or fuel consumption).

In the illustrated example, the storage 515 may include a set of scheduled flights 570 (e.g., planned flights for which a flight plan has been filed, but which have not yet departed, such as the airline schedules 210 and/or the pending filed flight plans list 245, each of FIG. 2) and a set of regulations 575 (which may correspond to published regulations provided by one or more regulatory entities, such as the published regulations list 240 of FIG. 2). As discussed above, the scheduled flights 570 may be evaluated to determine which flight(s) are affected by new or updated regulations. Similarly, the regulation(s) 575 may be evaluated to identify affected flights, to predict delays, to evaluate alternative routes, and the like. In some aspects, as discussed above, the scheduled flights 570 may be updated (e.g., using an alternative route or flight plan) in response to regulations 575. In some aspects, the aforementioned data may be saved in a remote database that connects to the computing device 500 via a network.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method, comprising:
accessing a regulation that restricts flight operations for one or more locations during one or more windows of time;
determining, based on the regulation, that a scheduled flight will be delayed by the regulation;
identifying one or more alternative routes for the scheduled flight; and
submitting a first alternative route of the one or more alternative routes as an updated flight plan for the scheduled flight.

2. The method of claim 1, further comprising determining that the first alternative route is not subject to the regulation.

3. The method of claim 1, further comprising determining that a delay of the first alternative route is less than the delay of the scheduled flight.

4. The method of claim 1, further comprising outputting, via a graphical user interface (GUI), an indication that the scheduled flight is affected by the regulation.

5. The method of claim 4, further comprising highlighting the indication based on a length of the delay.

6. The method of claim 5, wherein highlighting the indication based on the length of the delay comprises, in response to determining that the delay is greater than a threshold, emphasizing the indication.

7. The method of claim 1, further comprising outputting, for each respective alternative route of the one or more alternative routes, a respective indication via a graphical user interface (GUI).

8. The method of claim 7, further comprising determining, for each respective alternative route of the one or more alternative routes, a respective regulatory delay.

9. The method of claim 8, further comprising highlighting each respective indication based on the respective regulatory delays.

10. The method of claim 9, wherein highlighting each respective indication comprises, in response to determining that a delay of first alternative route is lower than the delay of the scheduled flight, emphasizing the indication of the first alternative route.

11. One or more non-transitory computer-readable media containing, in any combination, computer program code that, when executed by a computer system, performs an operation comprising:
accessing a regulation that restricts flight operations for one or more locations during one or more windows of time;
determining, based on the regulation, that a scheduled flight will be delayed by the regulation;
identifying one or more alternative routes for the scheduled flight; and
submitting a first alternative route of the one or more alternative routes as an updated flight plan for the scheduled flight.

12. The one or more non-transitory computer-readable media of claim 11, the operation further comprising at least one of:
determining that the first alternative route is not subject to the regulation; or
determining that a delay of the first alternative route is less than the delay of the scheduled flight.

13. The one or more non-transitory computer-readable media of claim 11, the operation further comprising:
outputting, via a graphical user interface (GUI), an indication that the scheduled flight is affected by the regulation; and
highlighting the indication based on a length of the delay.

14. The one or more non-transitory computer-readable media of claim 11, the operation further comprising:
outputting, for each respective alternative route of the one or more alternative routes, a respective indication via a graphical user interface (GUI);
determining, for each respective alternative route of the one or more alternative routes, a respective regulatory delay; and
highlighting each respective indication based on the respective regulatory delays.

15. The one or more non-transitory computer-readable media of claim 14, wherein highlighting each respective indication comprises, in response to determining that a delay of first alternative route is lower than the delay of the scheduled flight, emphasizing the indication of the first alternative route.

16. A system comprising:
one or more computer processors; and
one or more memories containing computer-executable instructions that, when executed by the one or more computer processors, perform an operation comprising:
accessing a regulation that restricts flight operations for one or more locations during one or more windows of time;
determining, based on the regulation, that a scheduled flight will be delayed by the regulation;
identifying one or more alternative routes for the scheduled flight; and
submitting a first alternative route of the one or more alternative routes as an updated flight plan for the scheduled flight.

17. The system of claim 16, the operation further comprising at least one of:
determining that the first alternative route is not subject to the regulation; or
determining that a delay of the first alternative route is less than the delay of the scheduled flight.

18. The system of claim 16, the operation further comprising:
outputting, via a graphical user interface (GUI), an indication that the scheduled flight is affected by the regulation; and
highlighting the indication based on a length of the delay.

19. The system of claim 16, the operation further comprising:
outputting, for each respective alternative route of the one or more alternative routes, a respective indication via a graphical user interface (GUI);
determining, for each respective alternative route of the one or more alternative routes, a respective regulatory delay; and
highlighting each respective indication based on the respective regulatory delays.

20. The system of claim 19, wherein highlighting each respective indication comprises, in response to determining that a delay of first alternative route is lower than the delay of the scheduled flight, emphasizing the indication of the first alternative route.
